(19) United States
(12) Patent Application Publication
(10) Pub. No.: US 2015/0226629 A1
(43) Pub. Date: Aug. 13, 2015

(54) SYSTEM AND METHOD FOR LEAK INSPECTION

(71) Applicant: ATONARP INC., Tokyo (JP)

(72) Inventor: Prakash Sreedhar Murthy, Tsukuba-shi (JP)

(73) Assignee: ATONARP INC., Tokyo (JP)

(21) Appl. No.: 14/419,586

(22) PCT Filed: Sep. 4, 2013
(86) PCT No.: PCT/JP2013/005228

§ 371 Date: Feb. 4, 2015

(30) Foreign Application Priority Data
Sep. 4, 2012 (JP) 2012-193683

(51) Int. Cl. G01M 3/16; G01N 27/62

(52) U.S. Cl. CPC G01M 3/16; G01N 27/622

(57) ABSTRACT

A leak inspection system includes: an ionizing unit that ionizes components included in a gas; a detection unit that detects the ionized components; a container that houses an object subjected to a leak inspection; a first path that supplies a first gas having a first component that is not ionized by the ionizing unit to one out of the object and the container and supplies gas inside one out of the object and the container via the ionizing unit to the detection unit; and a determination unit that determines, from a detection result of the detection unit, leakage of a second gas, which has a second component that is ionized by the ionizing unit, from inside another out of the object and the container. A leak inspection system with high detection precision can be provided at low cost.

### TECHNICAL FIELD

The present invention relates to a system and method for carrying out leak inspections.

### BACKGROUND ART

A leak detection system disclosed in Japanese Laid-Open Patent Publication No. 2011-107036 includes: a test chamber connected to a vacuum pump; a encapsulating means for setting helium gas in a test piece TP; a conveying means that conveys the test piece between a detection preparation position where it is possible to transfer the test piece into the test chamber and an encapsulating position where helium gas is set by the encapsulating means; a transferring means for transferring the test piece from the detection preparation position to a detection position inside the test chamber; a closing means that closes the test chamber in a state where a test piece in which helium gas has been set is present at the detection position; and a leak detecting means that detects helium that has leaked from the test piece when the inside of the test chamber has been evacuated to a predetermined pressure by the vacuum pump following the closing of the test chamber by the closing means.

PCT Publication WO2012/056709 discloses a system equipped with a unit for analyzing samples that was proposed by the present applicant. A unit for performing analysis includes: a functional unit that detects peaks that are present in a two-dimensional representation of data included in measurement data obtained by feeding a sample to an ion mobility sensor for measuring the ionic strength of ionized chemical substances that pass through an electric field controlled by at least two parameters, said two-dimensional representation indicating the ionic strength when a first parameter has been changed and the other parameter is fixed; a functional unit that classifies the peaks detected on the basis of the continuity between and the birth and death of the detected peaks and the other peaks that are present in the two-dimensional representation; and a functional unit that estimates the chemical substances contained in the sample on the basis of the classified peaks.

### DISCLOSURE OF THE INVENTION

A leak detection system that consumes helium has a high running cost. For this reason, there is demand for a leak inspection system and method that are low cost but have high precision.

An aspect of the present invention is a system including: an ionizing unit that ionizes components (molecules) included in a gas; a detection unit that detects the ionized components; a container (chamber) that houses an object subjected to a leak inspection; a first path that supplies a first gas having a first component that is not ionized by the ionizing unit to one out of the object and the container and supplies gas inside the one out of the object and the container via the ionizing unit to the detection unit; and a determination unit that determines, from a detection result of the detection unit, a leak of a second gas, which has a second component that is ionized by the ionizing unit, from inside another out of the object and the container. If a leak might occur from the object toward the container, the gas having the first component from the container is introduced via the ionizing unit to the detection unit but nothing will be detected by the detection unit so long as there is no leakage of the second gas from the object. On the other hand, if there is leakage of the second gas, the second component will be ionized by the ionizing unit and detected by the detection unit. Accordingly, the determination unit can easily and reliably determine whether leaks are present. If the leak direction is from the container toward the object, by connecting the object to the first path, it is possible to detect leaks to the inside of the object in the same way as described above.

In a system that evacuates the container housing the object to be subjected to a leak inspection, it is not possible to ensure a sufficient flow from the container to the detection unit, and it is not easy to remove impurities from the container and the piping system that is connected to the container. Also, in such a system, since there is no flow, time is required for the material leaking from the container to reach the detection unit.

In this system, it is possible for example to fill the first path including the container with the gas (carrier gas) having the first component that is not ionized by the ionizing unit. It is also possible to form a flow of gas with a predetermined flow rate on the first path, with such flow of gas not being detected by the detection unit. This means that it is easy to purge the first path including the container or the object and also when a minute leak is present at the object, the leaked components will be transported by the first gas and will reach the detection unit in a short time. Accordingly, it is possible to reduce the background (noise) of the detection unit and to precisely detect the presence of leaks at the object in a short time.

The ionizing unit may be an indirect ionizing unit that uses Ni₆₃ or corona discharge, or may be a direct ionizing unit such as a UV ionizing unit. When a UV ionizing unit is used, it is possible to use carbon dioxide, nitrogen, argon, or the like as the first component. Carbon dioxide is preferable because it is stable and has a sufficiently high ionization energy.

It is desirable for this system to further include a circulation unit that collects the first gas discharged from the detection unit in a supplying unit for the first gas that is connected to the first path. This makes it possible to further reduce the running cost.

It is desirable for this system to further include a second path that supplies or sets (encapsules) a second gas having a second component ionized by the ionizing unit in the object or the container. It is then possible to detect leaks from the object with even higher precision. One example of the second gas is air (dry air). Dry air has a low cost and components present in a small amounts or oxygen molecules included in the air are detected by being ionized using UV (ultraviolet) energy. The second gas may be gas including a small amount (0.1 to 10%) of molecules, such as acetone, that are easily ionized using UV.

Although the detection unit may be a mass spectrometry apparatus or a gas chromatography, if an ion mobility sensor such as a FAIMS is used, a vacuum atmosphere is unnecessary and detection is possible in substantially real time. Accordingly, it is possible to provide a system capable of detecting leaks in a short time at low cost.

Another aspect of the present invention is a method including carrying out a leak inspection of an object using a system including a detection unit that ionizes components included in a gas using an ionizing unit and detects the components. Carrying out a leak inspection includes the following steps.

1. Supplying a first gas having a first component that is not ionized by the ionizing unit to one out of the object and the container (chamber) and supplying gas inside the one out of the object and the container via the ionizing unit to the detection unit.

2. Determining, from a detection result of the detection unit, a leak of a second gas, which has a second component that is ionized by the ionizing unit, from inside another out of the object and the container.

Carrying out a leak inspection may further include supplying or sealing the second gas, which has molecules ionized by the ionizing unit, in the other out of the object and the container. It is desirable for the step of supplying to include collecting and circulating the first gas discharged from the detection unit.

### BRIEF DESCRIPTION OF THE DRAWINGS

FIG. 1 is a block diagram showing an arrangement of a leak inspection system.

FIG. 2 is a block diagram showing the construction of a purifier.

FIG. 3 is a flowchart showing a process for leak inspection by the leak inspection system.

### DETAIL DESCRIPTION

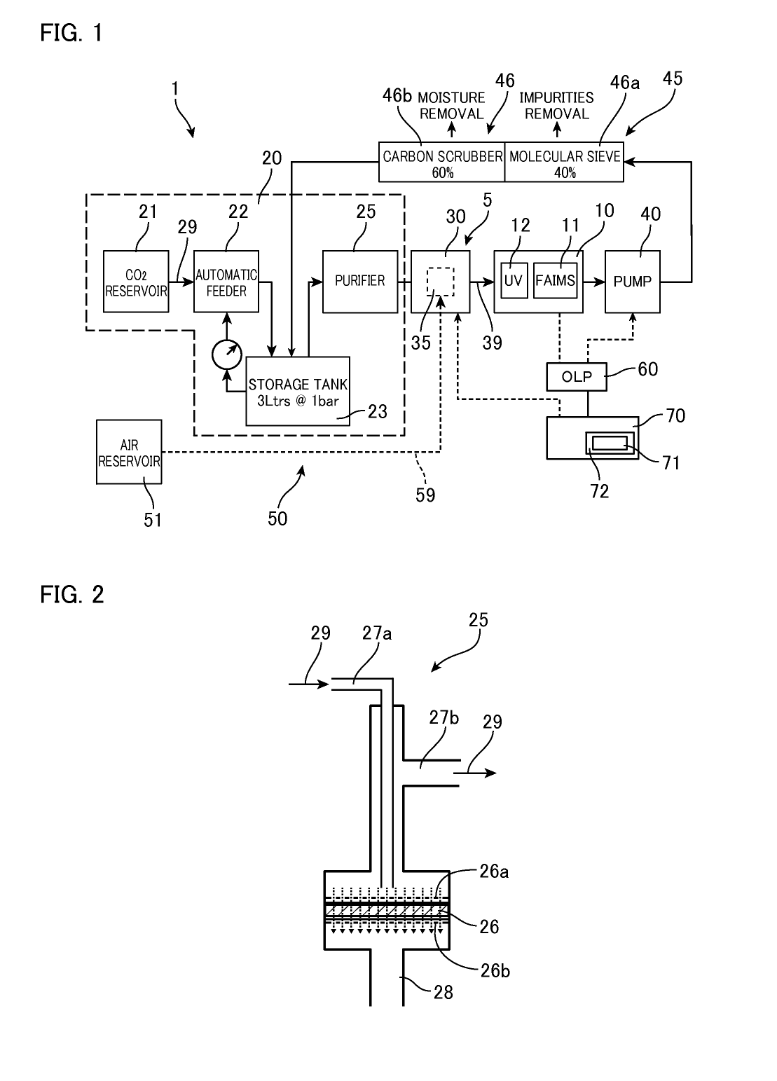

FIG. 1 shows an overview of a leak inspection system equipped with an ion mobility sensor. One example of an ion mobility sensor 11 is a FAIMS (Field Asymmetric waveform Ion Mobility Spectrometry, field asymmetric waveform ion mobility spectrometer, or DIMS (Differential Ion Mobility Spectrometry). With a FAIMS (FAIMS technology), the chemical substance (component) to be measured is a compound, composition, molecule, or other product that can be ionized by an ionizing unit 12 disposed upstream of the FAIMS 11. The FAIMS 11 uses a property whereby ion mobility is unique for each chemical substance and applies a differential voltage (DV, Dispersion Voltage, Vd voltage, field voltage, AC voltage, hereinafter “Vf”) and a compensation voltage (CV, compensation voltage, DC voltage, hereinafter “Vc”) to an ionized chemical substance while causing the ionized chemical substance to move in an electric field. By appropriately controlling the values of Vf and Vc, an ionized chemical substance that is the detection target will reach a detection electrode and be detected as a current value.

This leak inspection system 1 includes, from the upstream side, a supplying unit (carrier gas supplying unit) 20 that supplies a carrier gas 29, a closed container (vessel, chamber) 30 that houses an object 35 to be subjected to a leak inspection, a sensor unit 10 including the ionizing unit 12 and the FAIMS 11 that is the detection unit, and a suction pump 40. The object to be subjected to a leak inspection (test piece TP, device under test DUT) 35 may be one of various objects such as a heat exchanger like a radiator, a cylinder, a pressure vessel, and a pressure-resistant vessel. In the following explanation, an example where the direction of leaking is from the object 35 to the vessel 30 will be described. That is, the object 35 is an object, such as a radiator, where the internal pressure becomes high relative to the outside, and is a case where it is necessary to inspect for leaks from the object 35 to the outside.

The leak inspection system 1 includes a first path 5 that supplies the carrier gas 29 via the ionizing unit 12 to the FAIMS 11 that is the detection unit, the carrier gas 29 being carbon dioxide that is not ionized by the ionizing unit 12. The first path 5 includes the carrier gas supplying unit 20, the container 30, a pipe 39 that connects the container 30 and the sensor unit 10, and the sensor unit 10.

The leak inspection system 1 includes a determination unit 71 that determines, according to a detection result of the ionizing unit 12, leakage of a second gas, which includes a second component that is ionized by the ionizing unit 12, from inside the object 35 via the first path 5. The determination unit 71 may be included in a device (OLP, Olfaction Processor) 60 that controls the flow amount through the FAIMS 11 and has an analysis function for measurement data obtained from the FAIMS 11, or may be included in a control unit 70 that controls the entire leak inspection system 1. The control unit 70 is realized by general-purpose hardware resources (including a CPU and memory) of a personal computer or the like and runs a leak inspection application 72 provided by a program (program product). In the present embodiment, the determination unit (determination function) 71 is included in the leak inspection application 72 and the leak inspection application 72 controls the leak inspection system 1 and outputs a result showing the presence or absence of leaks.

The OLP 60 is provided as a single integrated device (semiconductor chip, ASIC, LSI) or a plurality of integrated chips (a chip set), includes a function of controlling the measurement conditions or environment of the FAIMS 11, a function of analyzing (interpreting, peruse) the measurement results according to the measurement conditions or the environment, and the like, and as one example is disclosed in detail in PCT application WO2012/056709 submitted by the present applicant.

The carrier gas supplying unit 20 supplies a gas composed of carbon dioxide as the carrier gas 29. To do so, the supplying unit 20 includes a carbon dioxide cylinder 21, a storage tank 23 for the carrier gas 29, a feeder (pressure controller) 22 that supplies the carrier gas (carbon dioxide) 29 from the cylinder 21 so that the pressure of the storage tank 23 reaches a slightly higher value than atmospheric pressure, for example, 1 bar, and a purifier (filter, cleaning apparatus) 25 for the carrier gas 29. Commercially available high-purity carbon dioxide has a purity of 99.995% or higher, and in the system 1, the purifier 25 is provided so that even higher purity carbon dioxide (CO₂, first component) gas is supplied to the chamber 30 as the carrier gas 29.

FIG. 2 shows one example of the purifier 25. This purifier 25 uses a diffusion membrane (permeable membrane, porous polymer film) 26 with high permselectivity to eliminate impurities 27 included in the carrier gas 29 and further raise the purity of the carrier gas 29. Examples of the diffusion membrane 26 include PDMS (polydimethylsiloxane) and hybrid silica. As one example, a microporous organic-inorganic hybrid membrane that has an average pore diameter of 0.1 to 0.6 nm is based on silica that is hydrothermally stable up to at least 200° C. in several types of medium, can be manufactured using a sol-gel process on short-chain, cross-linked silane, and has been reported to be suited to the separation of gases and the separation of water and other small molecule compounds from various organic compounds such as low molecular weight alcohols.

The purifier 25 includes an input pipe 27a that introduces the carrier gas 29 into an input side 26a of the diffusion membrane 26, an output pipe 27b that outputs the carrier gas 29 which has contacted the input side 26a of the diffusion membrane 26 and whose purity has been raised, and an exhaust pipe 28 that releases impurities such as water that have passed through the diffusion membrane 26 from the output side 26b of the diffusion membrane 26.

The leak inspection system 1 further includes a circulation unit 45 that collects and reuses the carrier gas 29 that has passed the sensor unit 10 in the carrier gas supplying unit 20. The circulation unit 45 includes a filter unit 46 that filters the exhaust of the suction pump 40 so that filtered carrier gas 29 is collected in the storage tank 23 of the carrier gas supplying unit 20. The filter unit 46 includes a molecular sieve 46a that adsorbs impurities and a carbon scrubber 46b that separates moisture. By collecting the carrier gas 29 whose purity has been raised by the purifier 25 in the supplying unit 20, it is possible to suppress the consumption of high-purity carbon dioxide and to reduce the running cost required for leak inspections.

The leak inspection system 1 further includes a second path (second supplying unit, leak gas supplying unit) 50 that supplies leak gas 59 to the inspected object 35 held in the chamber (container) 30. In this system, air (dry air) is used as the leak gas and the second path 50 connects an air reservoir 51 and the inspected object 35. The leak gas 59 may be supplied continuously to the inspected object 35 held in the chamber 30. Also, before placing the inspected object 35 in the chamber 30, the leak gas 59 may be introduced into the inspected object 35 and the supply opening may then be sealed. Although the leak gas 59 is not limited to dry air, it is possible to reduce the running cost by using air.

One example of the FAIMS 11 that is the detection unit is a MEMS sensor made by Owlstone. One example of the ionizing unit 12 ionizes a gas using UV (ultra-violet). The ionizing unit 12 may be an ionizer that uses Ni₆₃ (a 555 MBq β-ray source, 0.1 μSv/hr) or may be an ionizer that uses corona discharge. The ionizing unit 12 in the present embodiment includes a UV source such as a UV light emitting diode (UV-LED) or a UV lamp (UV low pressure lamp), and ionizes components included in the carrier gas 29 by emitting light of a short wavelength of 280 nm or below.

It is further desirable for the ionizing unit 12 to be a device that emits ultraviolet light of a VUV (vacuum ultraViolet rays) region with a wavelength of 200 to 10 nm or short (extra) ultraviolet light (extra ultraviolet, EUV) with a wavelength of 121 to 10 nm, and for the ionizing unit 12 to be an ultraviolet ray source that emits ultraviolet rays with a wavelength of 120 to 95 nm and ionization energy of around 10 to 13 eV. The sensor unit 10 of the leak inspection system 1 uses the ionizing unit 12 that is provided with an ultraviolet light source that emits ultraviolet light with a wavelength of 120 to 110 nm and ionization energy of around 10 to 10.6 eV.

It has been reported that the ionization energy of carbon dioxide is 13.79 to 14.4 eV, so that when an ionizing unit 12 that emits ultraviolet light of such energy level is used, the carbon dioxide will not be ionized. In the same way, it has been reported that the ionization energy of nitrogen molecules (N2) is 15 to 20 eV, so that nitrogen will also not be ionized. On the other hand, it has been reported that the ionization of oxygen (oxygen molecules, O2), including the formation of ozone, commences with ultraviolet rays with a wavelength of 130 nm or below, and it is believed that some of the oxygen in air will be ionized. In addition, organic polymers that are often suspended in air are ionized at 10 eV or lower. As one example, the ionization energy of benzene is 9.24 eV and the ionization energy of acetone is around 10.5 eV.

In this leak inspection system 1, high-purity carbon dioxide is supplied as the carrier gas 29 to the chamber (container) 30 that houses the inspected object 35 and is supplied via the pipe 39 to the sensor unit 10. At the sensor unit 10, out of the molecules included in the carrier gas 29, the molecules ionized by the ionizing unit 12 are detected by the FAIMS 11 that is the detection unit. Since the carrier gas 29 of this leak inspection system 1 is carbon dioxide, the carrier gas 29 is not ionized at the ionizing unit 12 and is not detected by the FAIMS 11. Accordingly, if there are no leaks at the inspected object 35 sealed (held) in the chamber 30, a flat spectrum where nothing is detected by the FAIMS 11 or a spectrum including a certain amount of white noise is outputted, and a result showing that nothing has been detected is outputted from the OLP 60. On receiving this result, the determination unit 71 of the leak inspection application 72 outputs a detection result showing that leaks were not observed for the inspected object 35.

On the other hand, if there is a leak at the inspected object 35, the leak gas (air) 59 set (encapsuled, sealed) in or supplied to the inspected object 35 will be released to the chamber 30. The air 59 is supplied to the sensor unit 10 via the first path 5 by the carrier gas 29. Oxygen in the air 59 included in the carrier gas 29 and other components such as minute amounts of organic substances are ionized by the ionizing unit 12 and reach the FAIMS 11. Accordingly, a spectrum including a positive and/or negative ion peak is outputted by the FAIMS 11, so that information showing that something has been detected is outputted from the OLP 60. It is not necessary for the OLP 60 to specify the detected molecules, and the determination unit (determination function) 71 receives notification that the OLP 60 has detected some kind of molecules and outputs a detection result showing that there is a leak at the inspected object 35.

The FAIMS 11 is capable of detecting minute amounts of components included in the supplied carrier gas 29, for example, components present in the carrier gas 29 with a concentration of the order of ppt to ppb. Accordingly, the leak inspection system 1 is capable of detecting minute leaks at the inspected object 35 with high precision. In addition, although it is necessary to supply around 1 to 1000 mL per minute of carrier gas 29 to carry out measurement at the FAIMS 11, by using carbon dioxide that is not ionized by the UV ionizing unit 12 as the carrier gas 29, it is possible to ensure that there is a sufficient flow of carrier gas without lowering the sensitivity of the FAIMS 11. Since the carrier gas flow is ensured, if a leak is present at the inspected object 35, components that have leaked will be supplied to the FAIMS 11 in a short time by the carrier gas 29. Accordingly, with the leak inspection system 1, it is possible to determine whether leaks are present or occurred in a short time and in substantially real time, and to greatly reduce the inspection time.

Also, it is possible to always ensure the carrier gas flow that flows through the chamber 30 and the pipe 39 included on the first path 5. This means that, using the carrier gas 29, it is possible to purge the chamber 30 and the pipe 39 that connects the chamber 30 and the sensor unit 10. Accordingly, it is possible to suppress the adhesion of impurities to the container 30 and the pipe 39 and to improve the precision of leak detection.

In addition, the gas used for checking leaks is the carbon dioxide (the first gas) 29 and air (the second gas) 59 and compared to conventional leak inspections that use helium, it is possible to greatly reduce the running cost. In addition, in the leak inspection system 1, by collecting and reusing the carrier gas 29 using the circulation unit 45, it is possible to further reduce the running cost. In addition, the entire leak inspection system 1 is controlled with a pressure that is around atmospheric pressure and it is not necessary to evacuate the inside of the chamber. Accordingly, it is not necessary to greatly increase the mechanical strength of the container and the pipes, and it is not necessary to provide a vacuum pump. This means that is also possible to reduce the equipment cost. It is also possible to heat the chamber (container) 30, and possible to carry out leak detection at high temperature.

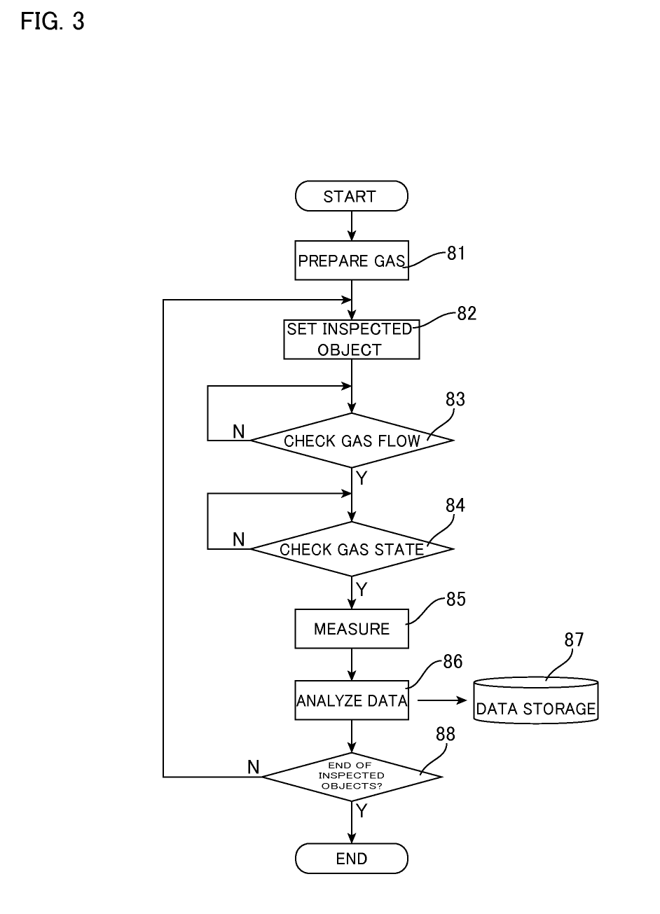

FIG. 3 shows, by way of a flowchart, the process that carries out leak inspection using the leak inspection system 1. In step 81, the carrier gas (carbon dioxide, the first gas) 29 and leak gas (air, the second gas) 59 are prepared. At the carrier gas supplying unit 20, the reservoir 21 supplies the carrier gas (carbon dioxide) 29 until a predetermined pressure is reached and the purifier 25 is activated. At the leak gas supplying unit 50, the leak gas (dry air) 59 is prepared in the reservoir 51. In step 82, the inspected object (DUT) 35 is held in the chamber 30 and the chamber 30 is closed. A loading and unloading chamber (air lock), such as a double door system, may be provided before and after loading into the measurement chamber 30, and it may be possible to continuously set the inspected objects 35 in the chamber 30 one after the other using a belt conveyor or the like.

When an inspected object 35 has been placed or housed in the chamber 30 and the chamber 30 has been closed, in step 83 the flow (flow amount) of the carrier gas 29 is checked and in step 84 the state of the carrier gas 29 is checked by the FAIMS 11. Once the flow amount of the carrier gas 29 is stable, the purity of the carrier gas 29 is sufficiently high, and impurities such as moisture and VOCs stop being detected by the FAIMS 11, in step 85 the leak gas 59 is supplied to the inspected object 35 in the chamber 30 and measurement by the FAIMS 11 is commenced. That is, the carrier gas 29 that will not be ionized by the ionizing unit 12 is supplied to the chamber (container) 30 in which the object 35 is held and the carrier gas 29 is supplied via the ionizing unit 12 to the FAIMS 11.

If the leak gas 59 is enclosed or sealed in the inspected object 35, once the conditions in steps 83 and 84 have been confirmed or an appropriate time has passed, it is determined whether a leak is present according to the measurement data produced then onwards by the FAIMS 11.

In step 86, the leak inspection application 72 analyzes the data obtained from the OLP 60 and determines whether there are leaks at the inspected object 35. That is, the determination unit 71 of the leak inspection application 72 determines, from the detection result of the FAIMS 11, leakage of dry air 59 from inside the object 35 by finding components of dry air 59 that have been ionized by the ionizing unit 12, and outputs using an appropriate means such as an alarm. The leak inspection application 72 may include a function that records the detection result on an appropriate recording medium 87 and/or outputs via a computer network.

In step 88, if there is a next inspected object 35, the processing returns to step 82, the inspected object 35 in the container 30 is replaced, and a leak inspection is commenced again.

Although a case where the leak direction is from the object 35 toward the container 30 is described in the above example, if the leak direction is from the container 30 toward the object 35, it is possible to carry out a leak inspection by connecting the object 35 to the carrier gas supplying unit 20 and connecting the object 35 via the pipe 39 to the sensor unit 10.

Also, dry air is used as the leak gas 59 in the example described above. The leak gas 59 may be normal air. However, when dry air is not used, time is required to remove moisture that adheres to the chamber 30 and the pipe 39, which increases the wait time until the conditions for a following leak test are established. Accordingly, the leak gas 59 should preferably be dry air. The leak gas 59 may be a gas that includes a small amount, for example around 0.1 to 10%, of acetone or another specified component that is highly volatile and is easily ionized using UV. When a leak has occurred at the chamber 30 or the pipe 39 or when time is necessary to purge the chamber 30 or the pipe 39, the occurrence of such a situation can be easily determined from the measurement results of the FAIMS 11. It is also desirable to set the concentration of such specified component in the leak gas 59 so that a concentration for which the sensitivity of the FAIMS 11 is highest, for example, at a ppb or sub ppb level, is produced when there is a leak at the inspected object 35.

The sensor that detects components that have leaked is not limited to a FAIMS and may be another type of ion mobility sensor or may be a mass spectrometer. However, since an ion mobility sensor is capable of measuring leaked components in air, an ion mobility sensor is favorable for a leak inspection system that is low cost and is easy to manage.

1. A system comprising:
an ionizing unit that ionizes components included in a gas;
a detection unit that detects the ionized components;
a container that houses an object subjected to a leak inspection;
a first path that supplies a first gas having a first component that is not ionized by the ionizing unit to one out of the object and the container and supplies gas inside the one out of the object and the container via the ionizing unit to the detection unit; and
a determination unit that determines, from a detection result of the detection unit, a leak of a second gas, which has a second component that is ionized by the ionizing unit, from inside another out of the object and the container.

2. The system according to claim 1,
further comprising a circulation unit that collects the first gas discharged from the detection unit in a supplying unit for the first gas that is connected to the first path.

3. The system according to claim 1,
further comprising a second path that supplies or sets the second gas in the another out of the object and the container.

4. The system according to claim 1,
wherein the ionizing unit is a UV ionizing unit, and
the first component is carbon dioxide.

5. The system according to claim 1,
wherein the second gas is air.

6. The system according to claim 1,
wherein the detection unit includes an ion mobility sensor.

7. A method including carrying out a leak inspection of an object using a system including a detection unit that ionizes components included in a gas using an ionizing unit and detects the components,
wherein carrying out a leak inspection comprises:
supplying a first gas having a first component that is not ionized by the ionizing unit to one out of the object and a container and supplying gas inside the one out of the object and the container via the ionizing unit to the detection unit; and
determining, from a detection result of the detection unit, a leak of a second gas, which has a second component that is ionized by the ionizing unit, from inside another out of the object and the container.

8. The method according to claim 7,
wherein carrying out a leak inspection further comprises supplying or setting the second gas in the another out of the object and the container.

9. The method according to claim 7,
wherein the supplying includes collecting and circulating the first gas discharged from the detection unit.
